(19) United States
(12) Patent Application Publication
(10) Pub. No.: US 2015/0177986 A1
(43) Pub. Date: Jun. 25, 2015

(54) INFORMATION PROCESSING DEVICE

(71) Applicant: Kabushiki Kaisha Toshiba, Minato-ku (JP)

(72) Inventor: Nobuhiro KONDO, Yokohama (JP)

(73) Assignee: Kabushiki Kaisha Toshiba, Minato-ku (JP)

(21) Appl. No.: 14/636,856

(22) Filed: Mar. 3, 2015

Related U.S. Application Data
(63) Continuation of application No. PCT/JP2013/056886, filed on Mar. 6, 2013.

(30) Foreign Application Priority Data
Sep. 4, 2012 (JP) 2012-194380

(51) Int. Cl. G06F 3/06; H04N 1/21; G06T 1/60

(52) U.S. Cl. CPC G06F 3/0605; G06T 1/60; H04N 1/2129; G06F 3/0679; G06F 3/0635; G06F 3/0659; G06F 2206/1014

(57) ABSTRACT

According to one embodiment, an information processing device includes: a host device, a semiconductor memory device with a nonvolatile semiconductor memory, and a communication path connecting the host device and the semiconductor memory device together,

### CROSS-REFERENCE TO RELATED APPLICATIONS

This application is a Continuation Application of PCT Application No. PCT/JP2013/056886, filed Mar. 6, 2013 and based upon and claiming the benefit of priority from Japanese Patent Application No. 2012-194380, filed Sep. 4, 2012, the entire contents of all of which are incorporated herein by reference.

### FIELD

An embodiment of the present invention relates to an information processing device.

### BACKGROUND

Unified Memory Architecture (UMA) is a technique using a graphical processing unit (GPU) or the like comprising a plurality of arithmetic processors integrated together and sharing one memory.

### BRIEF DESCRIPTION OF THE DRAWINGS

FIG. 1 is a diagram showing an example of a configuration of an information processing device according to an embodiment;

FIG. 2 is a diagram showing a memory structure in a device use area according to the embodiment;

FIG. 3 is a diagram illustrating a memory structure in an L2P cache tag area according to the embodiment;

FIG. 4 is a diagram illustrating a memory structure in an L2P cache area according to the embodiment;

FIG. 5 is a diagram illustrating a memory structure in a write cache tag area according to the embodiment;

FIG. 6 is a diagram illustrating a memory structure in a write cache area according to the embodiment;

FIG. 7 is a diagram illustrating an example of the data structure of a write command according to the embodiment;

FIG. 8 is a diagram showing an example of a format of a data transfer command according to the embodiment;

FIG. 9 is a diagram showing an example of flags contained in the data transfer command according to the embodiment;

FIG. 10A is a diagram showing an operation of a memory system receiving data via a third port, and FIG. 10B is a diagram showing an operation of the memory system receiving data via a second port; and

FIG. 11A is a diagram showing an operation of the memory system transmitting data via the third port, and FIG. 11B is a diagram showing an operation of the memory system transmitting data via the second port.

### DETAILED DESCRIPTION

In general, according to one embodiment, an information processing device includes:

a host device, a semiconductor memory device with a nonvolatile semiconductor memory, and a communication path connecting the host device and the semiconductor memory device together,

the host device includes:

a first storage section; and

a first control section to which the first storage section and the communication path are connected and which controls the first storage section,

the communication path includes:
a plurality of ports to each of which a priority is assigned,

the semiconductor memory device includes:
a second control section connected to the communication path to transmit, to the first control section, a request containing a first flag which determines the priority of the port based on a preferential order of an operation of transmitting or receiving data to or from the first storage section, and

upon receiving the request, the first control section carries out data transmission or reception between the first storage section and the second control section via the port corresponding to the priority based on the first flag contained in the request.

An embodiment will be described below with reference to the drawings. In the following description, components with substantially the same functions and configurations are denoted by the same reference numbers. The technical concepts of the embodiment do not limit the materials, shapes, structures, arrangements, and the like of components of the embodiment to the materials, shapes, structures, arrangements, and the like described below. The technical concepts of the embodiment may be varied within the scope of the claims.

### Embodiment

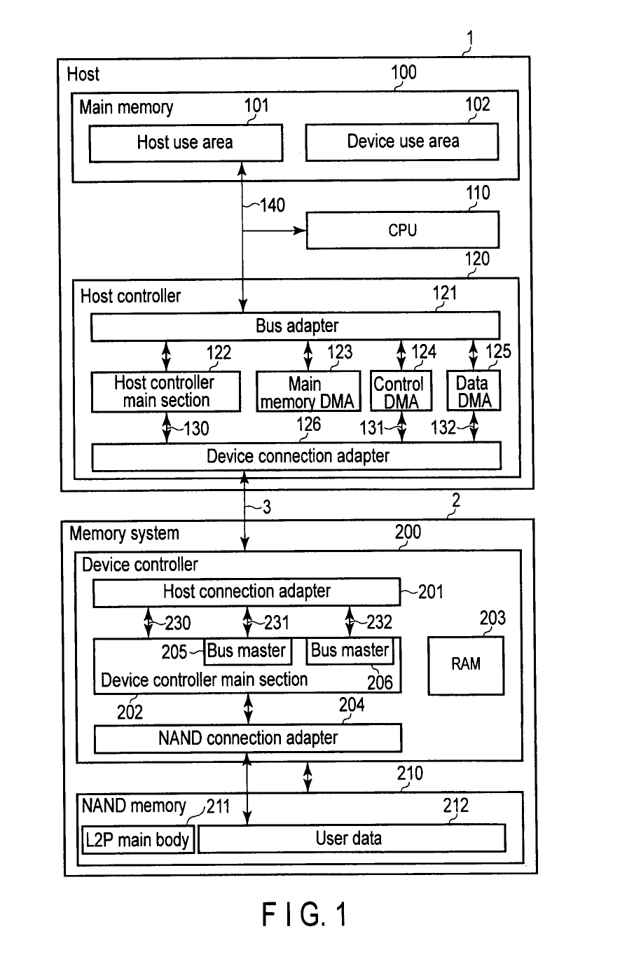

FIG. 1 schematically shows a basic configuration of an information processing device according to the present embodiment. The information processing device according to the present embodiment includes a host device (or an external device) 1 and a memory system 2 which functions as a memory device for the host device 1. The host device 1 and the memory system 2 are connected together via a communication path 3. A flash memory for embedding applications which conforms to the Universal Flash Storage (UFS) standard or a solid-state drive (SSD) is applicable to the memory system 2. The information processing device is, for example, a personal computer, cellular phone, or an image pickup device. As a communication standard for the communication path 3, for example, the Mobile Industry Processor Interface (MIPI) UniPro protocol has been adopted.

<Summary of the Memory System>

The memory system 2 includes a NAND flash memory 210 serving as a nonvolatile semiconductor memory and a device controller 200 which transfers data to and from the host device 1.

The NAND flash memory 210 is formed of at least one memory chip with a memory cell array. The memory cell array is formed of a plurality of memory cells arranged in a matrix. Moreover, each block is formed of a plurality of pages. Each of the pages is a unit of write and read.

Furthermore, the NAND memory 210 stores an L2P table 211 and user data 212 transmitted by the host device 1. The user data 212 includes, for example, an operating system program (OS) for which the host device 1 provides a runtime environment, a user program executed on an OS by the host device 1, and data input and output by the OS or a user program.

The L2P table 211 is a type of management information required to allow the memory system 2 to function as an external storage device for the host device 1 and is address translation information which associates a logical block address (LBA) used by the host device 1 to access the memory system 2 with a physical address (block address+page address+intra-page storage position) in the NAND memory 210. A part of the L2P table 211 is cached in an L2P cache area 300 in the host device 1 described below. To be distinguished from content cached in the L2P cache area 300, the L2P table 211 stores in the NAND memory 210 is hereinafter referred to as an L2P main body 211.

The device controller 200 includes a host connection adapter 201 which is a connection interface for the communication path 3, a NAND connection adapter 204 which is a connection interface between the device controller 200 and the NAND memory 210, a device controller main section 202 which controls the device controller 200, and a RAM 203.

The RAM 203 is used as a buffer configured to store data to be written to the NAND memory 210 or data read from the NAND memory 210. Furthermore, the RAM 203 is used as a command queue which queues commands related to write requests and read requests input by the host device 1. For example, the RAM 203 can be formed of a small-scale SRAM, a small-scale DRAM, or the like. Additionally, the functions of the RAM 203 may be provided by registers or the like instead of the RAM 203.

The device controller main section 202 controls data transfers between the host device 1 and the RAM 203 via the host connection adapter 201. The device controller main section 202 controls data transfers between the RAM 203 and the NAND memory 210 via the NAND connection adapter 204. In particular, the device controller main section 202 functions as a bus master in the communication path 3 between the device controller main section 202 and the host device 1 to transfer data using a first port 230. The device controller main section 202 further includes two other bus masters 205 and 206. A bus master 205 can transfer data to and from the host device 1 using a second port 231. A bus master 206 can transfer data to and from the host device 1 using a third port 232. The roles of ports 230 to 232 will be described below.

The device controller main section 202 includes, for example, a microcomputer unit with an arithmetic device and a storage device. The arithmetic device executes firmware pre-stored in the storage device to implement the functions of the device controller main section 202. The storage device may be omitted from the device controller main section 202, with the firmware stored in the NAND memory 210. Additionally, the device controller main section 202 may be configured using an ASIC.

Furthermore, the memory system 2 according to the present embodiment assumes a flash memory embedded in the information processing device conforming to the Universal Flash Storage (UFS) standard. Thus, commands and the like described conform to the UFS standard.

<Summary of the Host Device>

The host device 1 includes a CPU 110 which executes an OS and user programs, a main memory 100, and a host controller 120. The main memory 100, the CPU 110, and the host controller 120 are connected together by a bus 140.

The main memory 100 is configured using, for example, a DRAM. The main memory 100 includes a host use area 101 and a device use area 102. The host use area 101 is used as a program decompression area when the host device 1 executes an OS and user programs or as a work area when the host device 1 executes a program decompressed into the program decompression area. The device use area 102 is used as a cache area in which management information on the memory system 2 is cached and on which read and write operations are performed. Here, the L2P table 211 is taken as an example of management information cached in the memory system 2. Furthermore, write data is intended to be cached in the device use area 102.

<Summary of Ports>

Now, ports of the host device 1 and the memory system 2 according to the present embodiment will be described. The host device 1 and the memory system 2 according to the present embodiment are physically connected together by one line (communication path 3). However, the host device 1 and the memory system 2 are connected together by a plurality of access points described below and referred to as ports (also referred to as CPorts).

The host controller 120 includes a bus adapter 121 which is a connection interface for the bus 140, a device connection adapter 126 which is a connection interface for the communication path 3, and a host controller main section 122 which transfers data and commands to and from the main memory 100 and the CPU 110 via the bus adapter and which transfers data (including commands) to and from the memory system 2 via the device connection adapter 126. The host controller main section 122 is connected to the device connection adapter 126 by a first port 130. The host controller main section 122 can transfer data to and from the memory system 2 via the first port 130.

Furthermore, the host controller 120 includes a main memory DMA 123 which carries out DMA transfer between the host use area 101 and the device use area 102, a control DMA 124 which captures commands transmitted by the memory system 2 to access the device use area 102 and which transmits, to the memory system, status information indicative of how the host controller main section 122 is dealing with the device use area 102, a data DMA 125 which carries out DMA transfer between the device use area 102 and the memory system 2. The control DMA 124 is connected to the device connection adapter 126 by a second port 131. The control DMA 124 can transmit and receive commands and status information to and from the memory system 2 via the second port 131. Additionally, the data DMA 125 is connected between the device connection adapter 126 by a third port 132. The data DMA 125 can transmit and receive data to and from the memory system 2 via the third port 132.

The functions of the device connection adapter 126 and the host connection adapter 201 allow the first port 130, the second port 131, and the third port 132 to be associated with the first port 230, the second port 231, and the third port 232, respectively. Specifically, the device connection adapter 126 transmits content sent to the memory system 2 via the first port 130 to the device controller main section 202 via the first port 230. The device connection adapter 126 also transmits content sent to the memory system 2 via the second port 131 to the device controller main section 202 via the second port 231. The device connection adapter 126 further transmits content sent to the memory system 2 via the third port 132 to the device controller main section 202 via the third port 232.

Furthermore, the device connection adapter 126 transmits content sent to the host device 1 via the first port 230 to the host controller main section 122 via the first port 130. The device connection adapter 126 also transmits content sent to the host device 1 via the second port 231 to the control DMA 124 via the second port 131. The device connection adapter 126 further transmits content sent to the host device 1 via the third port 232 to the data DMA 125 via the third port 132. The content transmitted to the control DMA 124 and the data DMA 125 is, for example, transmitted to the host controller main section 122 via the bus adapter 121.

Each of ports 130 to 132 may include an input buffer which is used for communication with the memory system 2. The host controller main section 122, the control DMA 124, and the data DMA 125 are connected to the memory system 2 using separate input/output buffers. Thus, the host controller 120 can independently carry out communication with the memory system 2 using the host controller main section 122, communication with the memory system 2 using the control DMA 124, and communication with the memory system 2 using the data DMA 125. Furthermore, these communications can be switched to one another without the need to change the input/output buffers. Thus, the switching of the communication can be achieved quickly. This also applies to ports 230 to 232 provided in the memory system 2.

As described above, the information processing device according to the present embodiment includes the three types of ports, the first ports (also referred to as CPort 0) 130 and 230, the second ports (also referred to as CPort1) 131 and 231, and the third ports (also referred to as CPort2) 132 and 232.

Furthermore, a priority (traffic class, also referred to as TC or the like) is set for each of the ports. Specifically, priority 0 (low) is set for the first ports 130 and 230. Priority 1 (high) is set for the second ports 131 and 231. Priority 0 (low) is set for the third ports 132 and 232.

The first ports 130 and 230 are basically used when the host device 1 makes a request to the memory system 2. Either the second ports 131 and 231 or the third ports 132 and 232 are selected as appropriate by such a request from the memory system 2 as described below.

If the first ports 130 and 230 are not distinguished from each other, the first ports 130 and 230 are collectively referred to as the first port for simplification. Furthermore, if the second ports 131 and 231 are not distinguished from each other, the second ports 131 and 231 are collectively referred to as the second port for simplification. Moreover, if the third ports 132 and 232 are not distinguished from each other, the third ports 132 and 232 are collectively referred to as the third port for simplification.

<Priority (Traffic Class [TC])>

Now, the priority (traffic class [TC]) will be described. The priority (traffic class) is a preferential order used when the host device 1 transmits data or the like to the memory system 2. Specifically, the priority is a value indicating the order of data transfers or the like between the host device 1 and the memory system 2 when the data transfers contend against one another. The first embodiment sets, by way of example, two types of priorities, priority 1 (also referred to as TC1) and priority 0 (also referred to as TC0) which is lower than priority 1.

The priority is pre-set for each of the first to third ports. According to the present embodiment, the first port (CPort 0) is set to priority 0 (TC 0), the second port (CPort 1) is set to priority 1 (high) (TC 1), and the third port (CPort 2) is set to priority 0 (low) (TC 0). A method for selecting the priority will be described below.

<Summary of the Device Use Area>

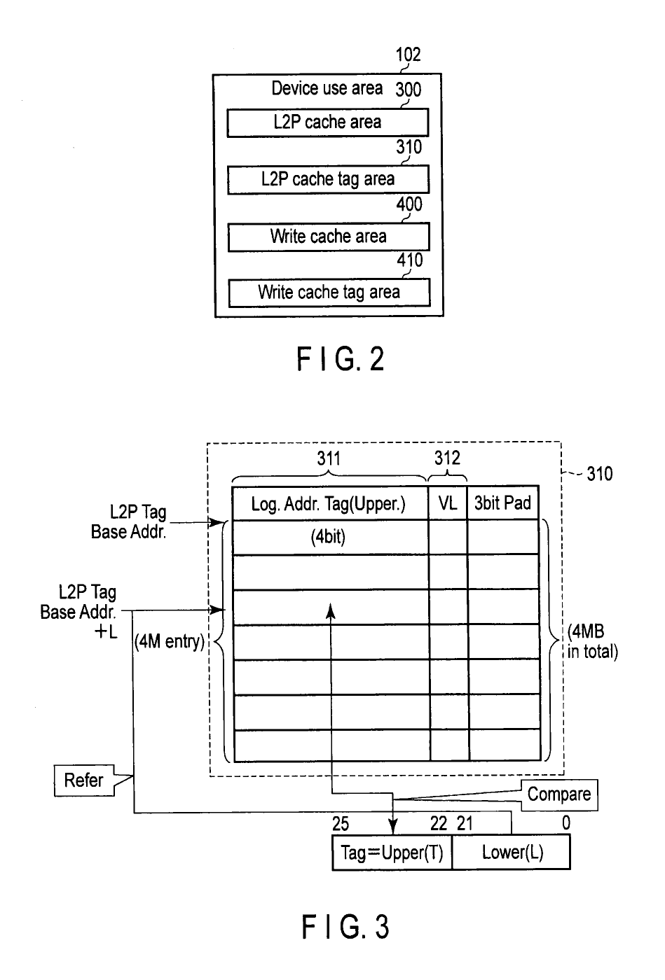

FIG. 2 is a diagram illustrating the memory structure of the device use area 102. As shown in FIG. 2, the device use area 102 includes an L2P cache area 300 in which a part of the L2P main body 211 is cached, an L2P cache tag area 310 in which tag information used for hit or miss determination for the L2P cache area 300 is stored, a write cache area 400 which is a memory area of a cache structure in which write data is cached, and a write cache tag area 410 in which tag information used for hit or miss determination for the write cache area 400 is stored.

<Memory Structure of the L2P Cache Tag Area>

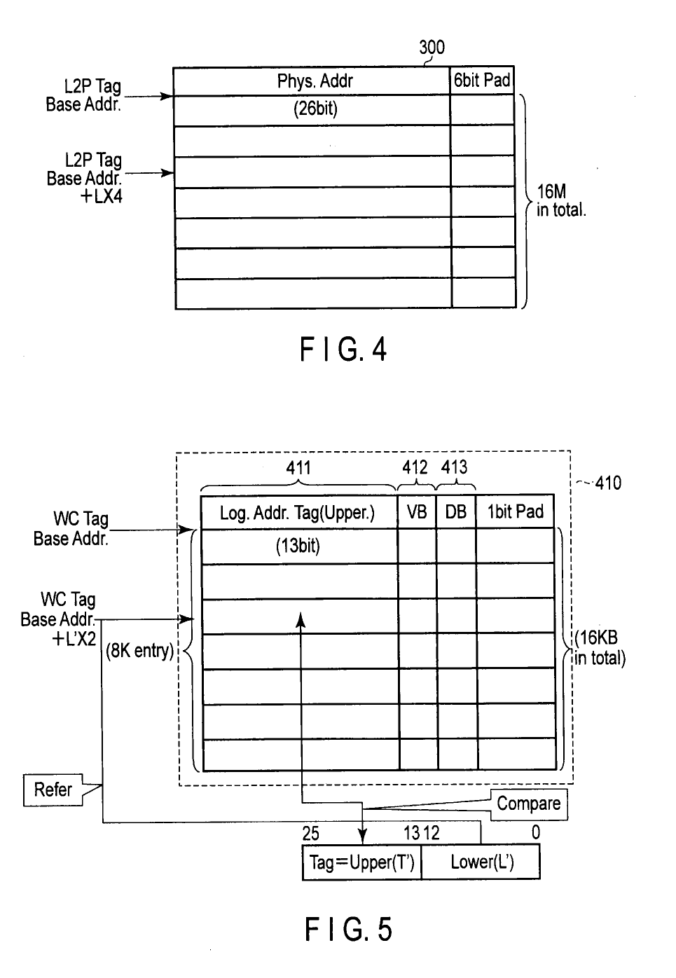

FIG. 3 is a diagram illustrating the memory structure of the L2P cache tag area 310. FIG. 4 is a diagram illustrating the memory structure of the L2P cache area 300. Here, by way of example, the LBA has a data length of 26 bits, and the L2P cache area 300 is intended to be referred to using the lower 22 bits of the LBA. In the description, the upper 4 bits of the LBA are represented as T, and the lower 22 bits of the LBA are represented as L. The LBA is intended to be assigned to each page forming the NAND memory 210 (here, the page is equivalent to 4 Kbytes).

Each of the cache lines forming the L2P cache area 300 stores a physical address (Phys. Addr.) for one LBA as shown in FIG. 4. The L2P cache area 300 includes 2²² cache lines. Each of the cache lines has a capacity of 4 bytes equivalent to a sufficient size to store 26 bits of physical address. Thus, the L2P cache area 300 has a total size of 2²²×4 bytes, that is, 16 Mbytes. Furthermore, the L2P cache area 300 is configured such that physical addresses corresponding to the LBA are stored in the L2P cache area 300 in order of the value of L. That is, the individual cache lines forming the L2P cache area 300 are read by referring to addresses each obtained by adding the page address of the L2P cache area 300 (L2P Base Addr.) to 4*L. An excess area in each of the 4-byte cache lines forming the L2P cache area 300, that is, the entire area of the 4-byte cache line except for the area in which the 26-bit physical address is stored, is represented as “Pad”. In the following tables, excess portions are represented as “Pad”.

Furthermore, as shown in FIG. 3, the value T serving as tag information is recorded in the L2P cache tag area 310 in order of the value of L for each of the cache lines stored in the L2P cache area 300. Each of the entries includes a field 311 in which tag information is stored and a field 312 in which a VL (Valid L2p) bit indicative of whether or not the cache line is valid is stored. Here, the L2P cache tag area 310 is configured such that T recorded in the L2P cache tag area 310 as tag information matches the upper digits T of the LBA corresponding to the physical address stored in the corresponding cache line (that is, the cache line referred to using L) in the L2P cache area 300. That is, whether or not the physical address corresponding to the upper digits T of the desired LBA is cached in the L2P cache area 300 is determined by referring to an address obtained by adding the base address of the L2P cache tag area 310 to the value of L forming the desired LBA, to determine whether or not the tag information stored in the referred-to position matches the value of T forming the desired LBA. If the tag information and the value of T match, the information processing device determines that the physical address corresponding to the desired LBA is cached. If the tag information and the value of T fail to match, the information processing device determines that the physical address corresponding to the desired LBA is not cached. T is a 4-bit value, and a VL bit has a capacity of 1 bit. Thus, each entry has a capacity of 1 byte. Therefore, the L2P cache tag area 310 has a size of 2²² multiplied by 1 byte, that is, a size of 4 Mbytes.

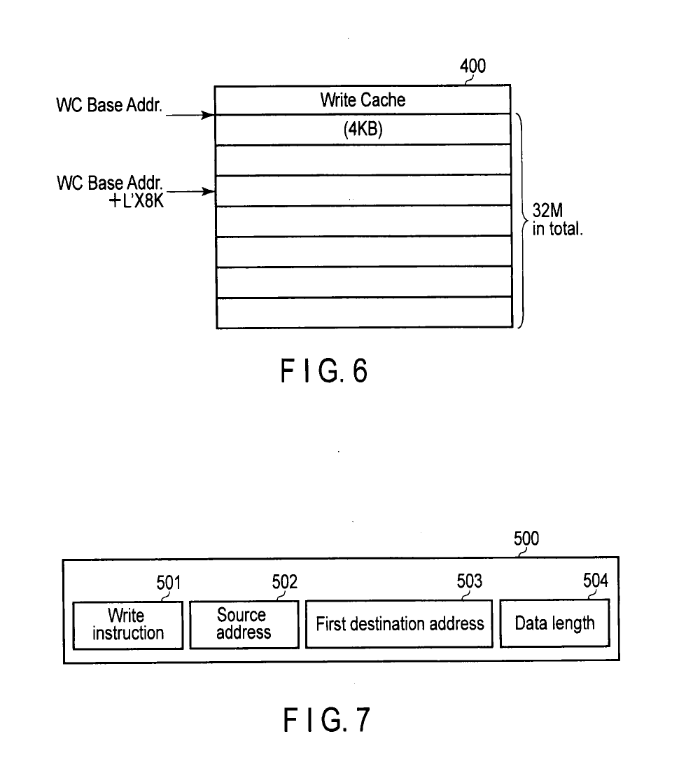

FIG. 5 is a diagram illustrating the memory structure of the write cache tag area 410. FIG. 6 is a diagram illustrating the memory structure of the write cache area 400. Here, the write cache area 400 is referred to using the value of the lower 13 bits of the LBA. In the following description, the value of the upper 13 bits of the LBA is represented as T′. The value of the lower 13 bits is represented as L′.

Write data of a page size is stored in the individual cache lines forming the write cache area 400, as shown in FIG. 6.

The write cache area 400 includes 2¹³ cache lines. Write data of a page size (here, 4 Kbytes) is cached in this cache line. Thus, the write cache area 300 has a total size of 2¹³×4 Kbytes, that is, 32 Mbytes.

Furthermore, in the write cache area 400, the corresponding write data is stored in order of the value of L′. That is, the individual cache lines forming the write cache area 400 are read by referring to addresses each obtained by adding the page address of the write cache area 400 (WC Base Addr.) to L′*8K.

Additionally, as shown in FIG. 5, T′ serving as tag information is recorded in the write cache tag area 410 in order of L′ for each of the cache lines stored in the write cache area 400. Each of the entries includes a field 411 in which tag information is stored, a field 412 in which a valid buffer (VB) bit indicative of whether or not the cache line is valid is stored, and a field 413 in which a dirty buffer (DB) bit indicative of whether the cached write data is dirty or clean.

The write cache tag area 410 is configured such that T′ recorded in the write cache tag area 410 as tag information matches the upper digits T′ of the LBA assigned to a page in which the write data stored in the corresponding cache line (that is, the cache line referred to using L′) in the write cache area 400 is to be stored. That is, whether or not the write data corresponding to the desired LBA is cached in the write cache area 400 is determined by referring to an address obtained by adding the base address of the write cache tag area 410 (WC Tag Base Addr.) to the value of L′ forming the upper digits T of the desired LBA, to determine whether or not the tag information stored in the referred-to position matches the value of T′ forming the desired LBA.

A dirty cache line refers to a state in which the write data stored in the cache line fails to match the data stored at the corresponding address on the NAND memory 210. A clean cache line refers to a state in which the write data and the stored data match. A dirty cache line is cleaned by being written back to the NAND memory 210. Each piece of tag information T′ in the write cache tag area 410 has a data length of 13 bits, and each of the DB bit and the VB bit requires a size of 1 bit. Thus, each entry has a capacity of 2 bytes. Therefore, the write cache tag area 410 has a size of 2¹³ multiplied by 2 bytes, that is, a size of 16 Kbytes.

The CPU 110 executes the OS and user programs, and based on a request from any of these programs, generates a write command to write data stored in the host use area 101 to the memory system 2. The generated write command is transmitted to the host controller 120.

<Summary of the Data Structure of a Write Command>

FIG. 7 is a diagram illustrating an example of the data structure of a write command. As shown in FIG. 7, a write command 500 includes a write instruction 501 indicating that the command 500 is intended to give an instruction to write data, a source address 502 in the host use area 101 at which write target data is stored, a first destination address 503 indicative of an address to which write data is to be written, and the data length 504 of the write data. The first destination address 503 is represented as the LBA.

The host controller main section 122 receives, via the bus adapter 121, the write command 500 transmitted by the CPU 110, and reads the source address 502 and the first destination address 503 both contained in the received write command 500. Then, the host controller main section 122 transfers the data stored at the source address 502 and the first destination address 503 to the memory system 2 via the device connection adapter 126.

The host controller main section 122 may utilize the main memory DMA 123 in reading the data stored at the source address 502. At this time, the host controller main section 122 sets the source address 502 and the data length 504 and the destination address at buffer addresses in the host controller main section 122, and activates the main memory DMA 123.

Furthermore, the host controller main section 122 can receive various commands other than the write command 500 from the CPU 110. Here, the host controller main section 122 enqueues the received command in a command queue and takes processing target commands from the command queue in order starting with the leading command. The area in which the data structure of the command queue is stored may be secured on the main memory 100 or configured by arranging a small-scale memory or register inside or near the host controller main section 122.

Additionally, the communication path between the host controller main section 122 and each of the main memory DMA 123, the control DMA 124, and the data DMA 125 is not limited to a particular path. For example, the bus adaptor 121 may be used as a communication path or a dedicated line may be provided and used as a communication path.

<Command Format>

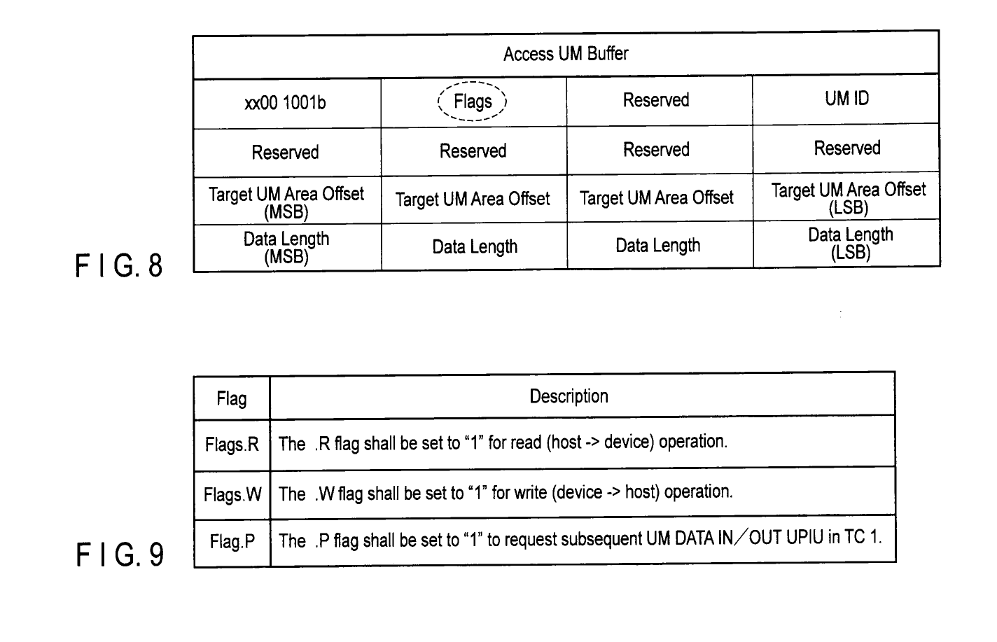

Now, the format of a data transfer command (also referred to as a request) according to the present embodiment will be described with reference to FIG. 8. FIG. 8 is a diagram showing an example of the format of the data transfer command according to the present embodiment.

As shown in FIG. 8, the data transfer command (Access UM Buffer) may contain various pieces of information when used to make a data transfer request to the host device 1. The data transfer command (Access UM Buffer) according to the present embodiment may specifically contain flag information (see dashed part of FIG. 8).

<Flags>

Now, with reference to FIG. 9, the flags contained in the data transfer command (Access UM Buffer) according to the present embodiment will be described. FIG. 9 shows an example of the flags contained in the data transfer command (Access UM Buffer) according to the present embodiment.

As shown in FIG. 9, the data transfer command (Access UM Buffer) according to the present embodiment contains three types of flag: R, W and P. Upon receiving a command from the host device 1, the memory system 2 sets these flags in the data transfer command.

[Flag R]

Flag R indicates that the subsequent operation reads data from the main memory 100 of the host device 1 into the memory system 2.

Specifically, if the subsequent operation reads data from the host device 1 into the memory system 2, flag R is set.

[Flag W]

Flag W indicates that the subsequent operation writes data from the memory system 2 into the main memory 100 of the host device 1.

If the subsequent operation writes data from memory system 2 to the host device 1, flag W is set.

[Flag P] Flag P determines the priority of the subsequent data input sequence (UM DATA IN) from the memory system 2 to the host device 1 or the subsequent output sequence (UM DATA OUT) from the host device 1 to the memory system 2. Each sequence is carried out via the port corresponding to the selected priority.

Specifically, flag P is set if the priority of the data input sequence (UM DATA IN) from the memory system 2 to the host device 1 or the output sequence (UM DATA OUT) from the host device 1 to the memory system 2 is high. Upon recognizing that flag P is set, the host device 1 transmits and receives data via the second port set to priority 1 (high).

Flag P is cleared if the priority of the data input sequence (UM DATA IN) from the memory system 2 to the host device 1 or the output sequence (UM DATA OUT) from the host device 1 to the memory system 2 is low. Thus, upon recognizing that flag P has been cleared, the host device 1 transmits and receives data via the third port with priority 0 (low).

<Read Operation>

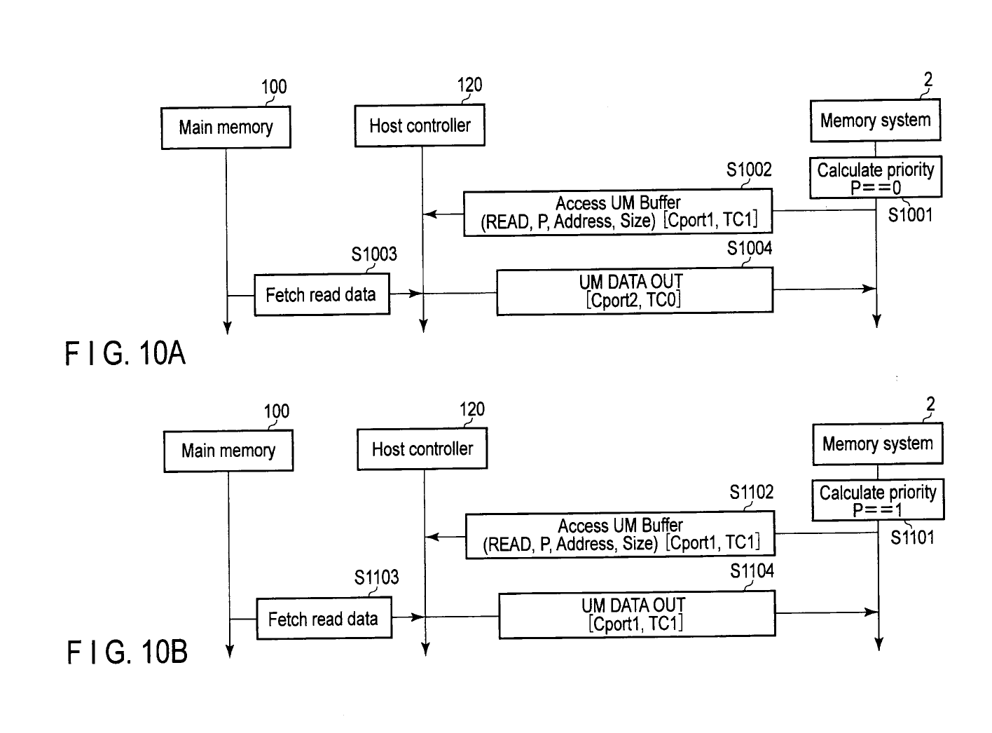

Now, an example of operations performed by the information processing device if the memory system 2 reads data from the host device 1 will be described with reference to FIG. 10. FIG. 10A is a diagram showing an operation in which the memory system 2 receives data via the third port. FIG. 10B is a diagram showing an operation in which the memory system 2 receives data via the second port.

First, an operation performed in the following case will be described: the information processing device includes two priority settings (0, low priority; 1, high priority) for the communication path 3, and when a data transfer is requested, the priority of the communication path 3 used for the corresponding data transfer is constantly maintained at 0, as shown in FIG. 10A.

[Step S1001]

The device controller main section 202 determines that priority 0 is to be used when receiving data from the host device 1. Thus, the device controller main section 202 clears flag P in the data transfer command (Access UM Buffer). Furthermore, the device controller main section 202 is to read data from the host device 1, and thus sets flag R in the data transfer command (Access UM Buffer).

[Step S1002]

The device controller main section 202 transmits a command (Access UM Buffer) to read data stored in the device use area 102 and including information such as: flag R, set; flag P, clear; address; and size (READ; P==0; Address; Size). The command is transmitted to the host device 1 via the second port with priority 1 (high) (CPort 1; TC 1).

[Step S1003]

Upon receiving, from the memory system 2, the command to read data, the host controller 120 fetches data from the device use area 102 based on information such as: flag R, set; flag P, clear; address; and size (READ; P==0; Address; Size).

[Step S1004]

Then, based on flag P contained in the command (Access UM Buffer) to read data received from the memory system 2, the host controller 120 transfers read data to the memory system 2 via the third port with priority 0 (CPort 2; TC 0) (UM DATA OUT).

Now, an operation performed in the following case will be described: the information processing device includes two priority settings (0, low priority; 1, high priority) for the communication path 3, and when a data transfer is requested, the priority of the communication path 3 used for the corresponding data transfer is constantly maintained at 1, as shown in FIG. 10B.

[Step S1101]

The device controller main section 202 determines that priority 1 is to be used when receiving data from the host device 1. Thus, the device controller main section 202 sets flag P in the data transfer command (Access UM Buffer). Furthermore, the device controller main section 202 is to read data from the host device 1, and thus sets flag R in the data transfer command (Access UM Buffer).

[Step S1102]

The device controller main section 202 transmits a command (Access UM Buffer) to read data stored in the device use area 102 and including information such as: flag R, set; flag P, set; address, and size (READ; P==1; Address; Size). The command is transmitted to the host device 1 via the second port with priority 1 (high) (CPort 1; TC 1).

[Step S1103]

Upon receiving, from the memory system 2, the command (Access UM Buffer) to read data, the host controller 120 fetches data from the device use area 102 based on information such as: flag R, set; flag P, set; address, and size (READ; P==1; Address; Size).

[Step S1104] Then, based on flag P contained in the command (Access UM Buffer) to read data received from the memory system 2, the host controller 120 transfers read data to the memory system 2 via the third port with priority 1 (CPort 1; TC 1) (UM DATA OUT).

<Write operation>

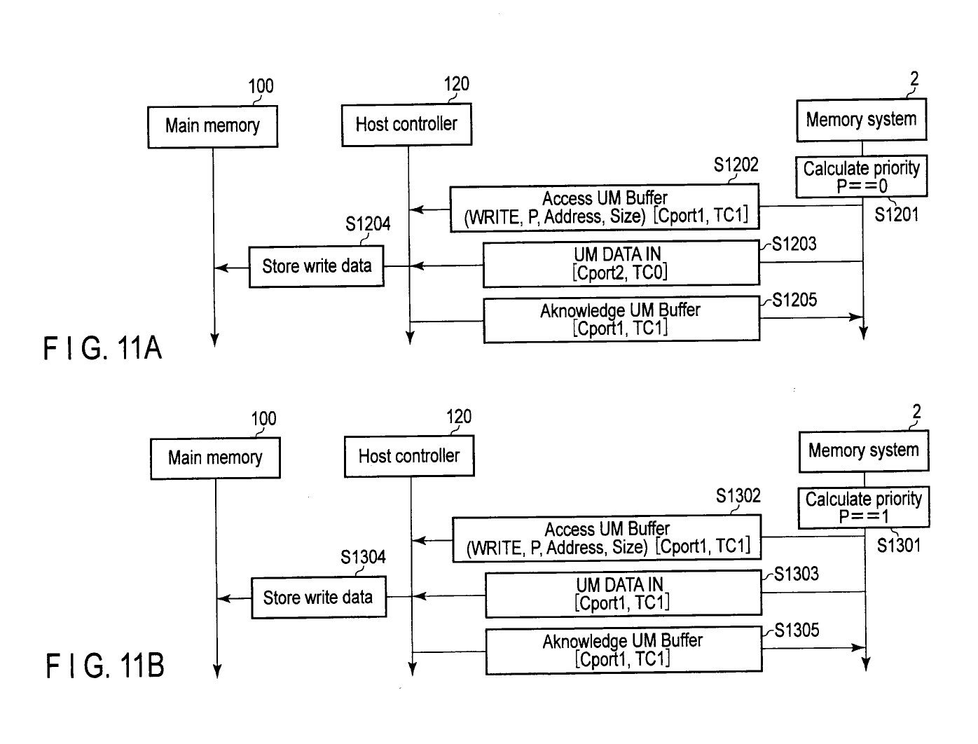

Now, an example of operations performed by the information processing device if the memory system 2 writes data to the host device 1 will be described with reference to FIG. 11. FIG. 11A is a diagram showing an operation in which the memory system 2 transmits data via the third port. FIG. 11B is a diagram showing an operation in which the memory system 2 transmits data via the second port.

First, an operation performed in the following case will be described: the information processing device includes two priority settings for the communication path 3, and when a data transfer is requested, the priority of the communication path 3 used for the corresponding data transfer is constantly maintained at 0, as shown in FIG. 11A.

[Step S1201]

The device controller main section 202 determines that priority 0 is to be used when transmitting data to the host device 1. Thus, the device controller main section 202 clears flag P in the data transfer command (Access UM Buffer) (P==0). Furthermore, the device controller main section 202 is to write data to the host device 1, and thus sets flag R in the data transfer command (Access UM Buffer).

[Step S1202]

The device controller main section 202 transmits a request command (Access UM Buffer) to read data stored in the device use area 102 and including information such as: flag W, set; flag P, clear; address; and size (WRITE; P==0; Address; Size). The command is transmitted to the host device 1 via the second port with priority 1 (CPort 1; TC 1).

[Step 1203]

Upon receiving, from the memory system 2, the command (Access UM Buffer) to write data, the host controller 120 receives the write data from the memory system 2 (UM DATA IN) based on information such as: flag W, set; flag P, clear; address; and size (WRITE; P==0; Address; Size). At this time, the host controller 120 receives the write data from the memory system 2 via the third port with priority 0 (CPort 2; TC 0), based on flag P contained in the command (Access UM Buffer) to write data received from the memory system 2.

[Step S1204]

The host controller 120 stores the write data received from the memory system 2 in the device use area 102.

[Step S1205]

When the write data is stored in the device use area 102, the host controller 120 transmits a notification command (Acknowledge UM Buffer) meaning that the storage has been completed, to the memory system 2 via the second port with priority 1 (CPort 1; TC 1). This completes the write of data from the memory system 2 to the host device 1.

Now, an operation performed in the following case will be described: the information processing device includes two priority settings for the communication path 3, and when a data transfer is requested, the priority of the communication path 3 used for the corresponding data transfer is constantly maintained at 1, as shown in FIG. 11B. [Step S1301]

The device controller main section 202 determines that priority 1 is to be used when transmitting data to the host device 1. Thus, the device controller main section 202 sets flag P in the data transfer command (Access UM Buffer) (P==1). Furthermore, the device controller main section 202 is to write data to the host device 1, and thus sets flag W in the data transfer command (Access UM Buffer).

[Step S1302]

The device controller main section 202 transmits a command (Access UM Buffer) to write data received from the memory system 2 and including information such as: flag W, set; flag P, set; address; and size (WRITE; P==1; Address; Size). The command is transmitted to the host device 1 via the second port with priority 1 (CPort 1; TC 1).

[Step 1303]

Upon receiving, from the memory system 2, the command (Access UM Buffer) to write data, the host controller 120 receives the write data from the memory system 2 (UM DATA IN) based on information such as: flag W, set; flag P, set; address; and size (WRITE; P==1; Address; Size). At this time, the host controller 120 receives the write data from the memory system 2 via the second port with priority 1 (CPort 1; TC 1), based on flag P contained in the command (Access UM Buffer) to write the data received from the memory system 2.

[Step S1304]

The host controller 120 stores the write data received from the memory system 2 in the device use area 102.

[Step S1305]

When the write data is stored in the device use area 102, the host controller 120 transmits a notification command (Acknowledge UM Buffer) meaning that the storage has been completed, to the memory system 2 via the second port with priority 1 (CPort 1; TC 1). This completes the write of data from the memory system 2 to the host device 1.

In connection with the operations described in the present embodiment, when a data transfer is requested, the memory system 2 constantly maintains the priority of the communication path 3 which is used for the corresponding data transfer at 0 or 1. However, the device controller main section 202 may switch the priority (0, low priority; 1, high priority) as appropriate based on a predetermined condition.

Furthermore, the above-described operations (read operation and write operation) of the memory system 2 may be performed if the memory system 2 receives the write command 500 from the host device 1 or may be actively performed by the memory system 2.

<Advantageous Effects of the Memory System According to the Present Embodiment>

According to the present embodiment, the information processing device includes the host device 1, the semiconductor memory device 2 with the non-volatile semiconductor memory 210, and the communication path 3 which connects the host device 1 and the semiconductor memory device 2 together. The host device 1 includes the first storage section 100 and the first control section 120 to which the first storage section 100 and the communication path 3 are connected and which controls the first storage section. The communication path 3 includes the plurality of ports to each of which the priority is assigned. The semiconductor memory device 2 includes the second control section 200 connected to the communication path 3 to transmit, to the first control section 120, data including the first flag (flag P) which determines the priority based on the preferential order of the operation of transmitting or receiving data to or from the first storage section 100. Furthermore, upon receiving the data transfer request, the first control section 120 carries out data transmission and reception between the first storage section 100 and the second control section 200 via the port corresponding to the priority, based on the first flag contained in the request. Furthermore, the priority includes first priority 0 and second priority 1, which is lower than first priority 0. The second control section 200 includes, in the first command, the second flag (flag R) indicating that the subsequent operation reads data from the first storage section 100 or the third flag (flag W) indicating that the subsequent operation writes data to the first storage section 100.

The memory system 2 according to the present embodiment can control the priority when transmitting and receiving data to and from the host device 1.

Commands for data transfer conventionally have no mechanism for controlling the priority. This precludes the priority from being selected as appropriate regardless of the type, size, or the like of data when the data is transmitted or received.

As described above, the priority specifies the preferential order of processing. Specifically, when the host device 1 is packed with a plurality of requests contending against one another, for example, a process with a high priority is carried out earlier than a process with a low priority.

As described above, the memory system 2 according to the present embodiment can include, in a request for data transfer itself, various types of flag information including information indicative of the priority of the data transfer. Examples of the flags include flag R meaning that the subsequent operation reads data from the host device 1, flag W meaning that the subsequent operation writes data to the host device 1, and flag P indicative of the priority of the subsequent sequence.

In particular, flag P included in the request itself allows the priority of the subsequent data in/out to be determined at the stage of the request made to the host device 1. The ability of the memory system 2 to control the priority as appropriate allows the performance of the memory system 2 as a whole to be optimized.

<Modifications>

The embodiments have been described using the UFS memory device. However, the present invention is not limited to the UFS memory device. Any memory system may be used provided that for example, the memory system is based on a client server model. More specifically, any memory system is applicable provided that the memory system allows such flag information as described above (flags R, W, P and the like) to be added to commands.

In addition, the embodiments have been described using the UFS memory device. However, any semiconductor memory device operating similarly to the UFS memory device is also applicable to other memory cards, memory devices, internal memories, or the like and can exert advantageous effects similar to those in the present embodiment and the second embodiment. Additionally, the flash memory 210 is not limited to the NAND flash memory but may be any other semiconductor memory.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a host device, a semiconductor memory device with a nonvolatile semiconductor memory, and a communication path connecting the host device and the semiconductor memory device together,
wherein the host device comprises:
a first storage section; and
a first control section to which the first storage section and the communication path are connected and which controls the first storage section,
the communication path comprises:
a plurality of ports to each of which a priority is assigned,
the semiconductor memory device comprises:
a second control section connected to the communication path to transmit, to the first control section, a first command containing a first flag which indicates a priority of the port of an operation of transmitting or receiving data to or from the first storage section, and
upon receiving the first command, the first control section carries out data transmission or reception between the first storage section and the second control section via the port assigned a priority corresponding to the priority indicated by the first flag based on the first flag contained in the first command.

2. The device according to claim 1, wherein the first control section generates a second command, and
upon receiving the second command from the first control section, the second control section transmits the first command succeeding the second command to the first control section.

3. The device according to claim 1, wherein the priority includes a first priority and a second priority higher than the first priority.

4. The device according to claim 3, wherein the second control section constantly sets the priority to the first priority.

5. The device according to claim 3, wherein the second control section constantly sets the priority to the second priority.

6. The device according to claim 3, wherein the second control section selects the first priority or the second priority based on a predetermined condition.

7. The device according to claim 1, wherein the second control section includes, in the first command, a second flag indicating that a subsequent operation reads data from the first storage section or a third flag indicating that the subsequent operation writes data to the first storage section.

8. An information processing device comprising a host device, a semiconductor memory device with a nonvolatile semiconductor memory, and a communication path connecting the host device and the semiconductor memory device together,
wherein the host device comprises:
a first storage section; and
a first control section to which the first storage section and the communication path are connected and which controls the first storage section,
the communication path comprises:
a plurality of ports to each of which a priority is assigned,
the semiconductor memory device comprises:
a second control section configured to transmit a first command, to the first control section, which comprising a first flag indicating that a subsequent operation reads data from the first storage section or a second flag indicating that the subsequent operation writes data to the first storage section, and
upon receiving the first command, the first control section carries out data transmission and reception between the first storage section and the second control section via the port corresponding to the priority, based on the first flag or the second flag contained in the first command.

9. A memory system comprising a nonvolatile semiconductor memory and connected to a host device through a communication path, the host device comprising a first control section,
the memory system comprising:
a second control section connected to the communication path and configured to transmit a first command to the first control section of the host device, the first command comprising a first flag which indicates priority of an operation of transmitting or receiving data to or from a first storage section of the host device, the first control section being connected to the first storage section and the communication path and configured to control the first storage section,
wherein upon receipt of the first command, the first control section is configured to perform data exchange between the first storage section and the second control section based on the first flag comprised in the first command through a port of a plurality of ports of the communication path to each of which priority is assigned, and
the port is assigned a priority corresponding to the priority indicated by the first flag.

10. The memory system according to claim 9, wherein upon receiving a second command generated by the first control section from the first control section, the second control section is configured to transmit the first command subsequent to the second command to the first control section.

11. The memory system according to claim 9, wherein the priority include a first priority, and a second priority higher than the first priority.

12. The memory system according to claim 11, wherein the second control section is set to have the first priority at all times.

13. The memory system according to claim 11, wherein the second control section is set to have the second priority at all times.

14. The memory system according to claim 11, wherein the second control section selects either the first priority or the second priority based on a predetermined condition.

15. The memory system according to claim 9, wherein the second control section is configured to include, in the first command, either a second flag indicating that a subsequent operation is an operation of reading data from the first storage section or a third flag indicating that the subsequent operation is an operation of writing data in the first storage section.
